(19) United States
(12) Patent Application Publication
(10) Pub. No.: US 2009/0025235 A1
(43) Pub. Date: Jan. 29, 2009

(54) Universal marker holder

(76) Inventor: Danny Larry Jabocs, Falkville, AL (US)

Correspondence Address: Danny Jacobs, 116 Summerford-Orr Rd, Falkville, AL, 35622, US

(21) Appl. No.: 11/880,643

(22) Filed: Jul. 24, 2007

(51) Int. Cl. B43L 9/00

(52) U.S. Cl. 33/27.01; 33/42; 33/668

(57) ABSTRACT

A tool used to position and attach various marking instruments to an arc forming device such as U.S. Pat. No. 6,223,443,B1, previously disclosed and used here for reference purposes only.

### CROSS REFERENCE TO RELATED APPLICATIONS

This application claims benefit of U.S. provisional application No. 60/721,897 and includes for reference purposes only U.S. Pat. No. 6,223,443 B1

### STATEMENT REGARDING FEDERALLY SPONSORED RESEARCH OR DEVELOPMENT

Not applicable

### REFERENCE TO A MICROFICHE APPENDIX

Not applicable

### BACKGROUND OF THE INVENTION

This invention relates to arc forming devices and other apparatus wherein a marking instrument is fastened to a tape measure housing, trammels, dividers, etc.

At present, most available marker holders accept scribe points or standard pencils only. This is often a frustrating inconvenience, whereas different materials to be marked require different marking instruments.

Accordingly, it is an object of this invention to provide a universal marker holder that will accept a variety of marking instruments including felt tipped markers, hexagon or round pencils, flat or round soapstone, carpenter pencils, and many others.

### BRIEF DESCRIPTION OF THE SEVERAL VIEWS OF THE DRAWINGS

FIG. 1 is a perspective view showing the universal marker holder with a felt marker. The dashed lines represent an arc forming device U.S. Pat. No. 6,223,443B1 and is used for reference only.

FIG. 2 is a top view showing the cross-section of a felt marker (6).

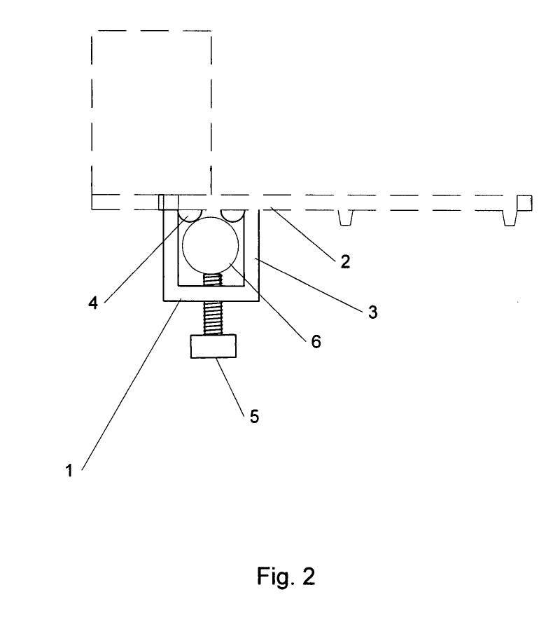

FIG. 3 is a top view showing the cross-section of a carpenter's pencil (7).

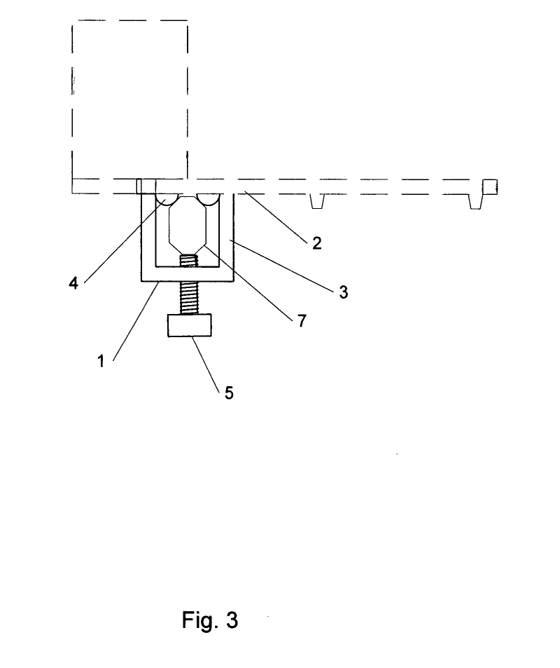

FIG. 4 is a top view showing the cross-section of a standard round pencil (8).

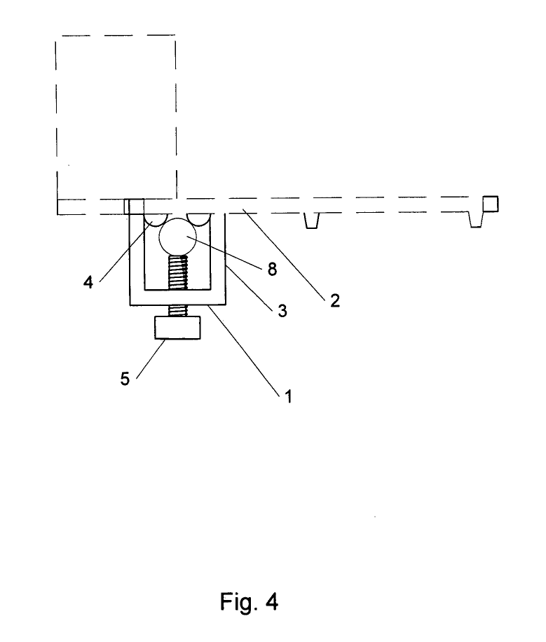

FIG. 5 is a top view showing the cross-section of a stand hexagon pencil (9).

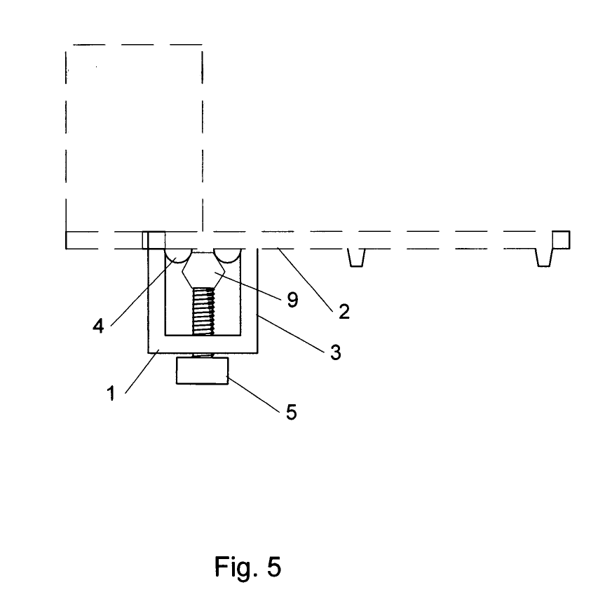

### DETAILED DESCRIPTION OF THE INVENTION

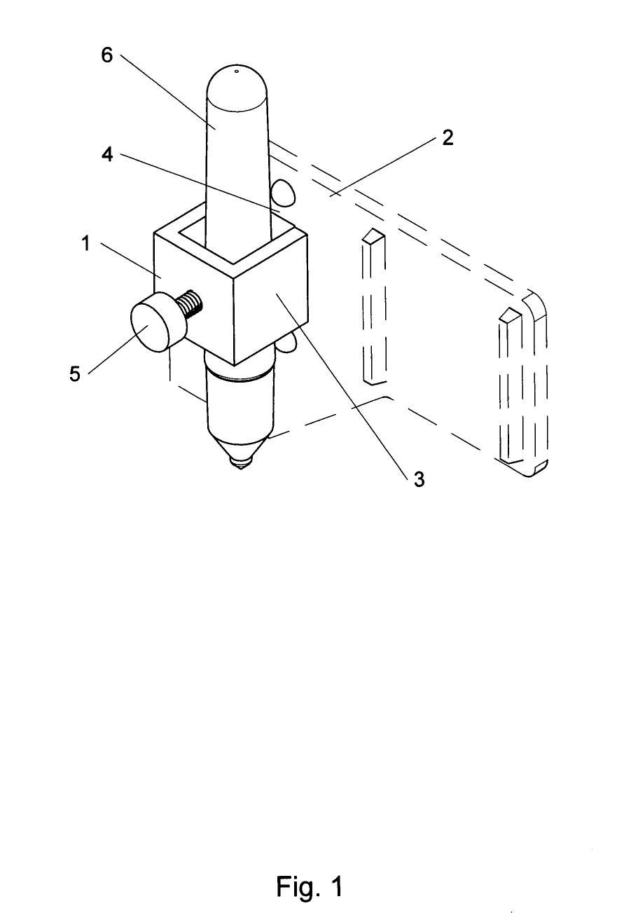

Referring to FIG. 1, the universal marker holder comprises a front wall 1, a rear wall 2, and opposing side walls 3.

The front wall disposes a thumb screw 5 located symmetrical thereto a marking instrument 6.

The rear wall disposes two or more extruded contours 4, wherein the contours operate to position marking instrument 6 while thumb screw 5 operates to secure the marking instrument.

In conclusion of this detailed description of the invention, it should be noted that while there has been shown and described a preferred embodiment of the invention, it is understood that changes in structure, size, and materials can be made by those skilled in the art without departing from the advantages and improvements defined in the following claims.

1. (canceled)

2. (canceled)

3. (canceled)

4. (canceled)

5. (canceled)

6. A tool defining a universal marker holder used to position and fasten a variety of marking instruments to a tape measure housing, trammels, dividers and similar devices wherein a marking instrument is rotated about a fixed point to draw circles, arcs, or intersecting arcs on template paper, sheet metal, plywood, drywall, and similar construction materials.

7. The tool of claim 6, wherein said marker holder comprises a front wall, a rear wall, and opposing side walls cooperating to position and fasten a variety of marking instruments to a tape measure housing, trammels, dividers, and similar devices wherein a soapstone, carpenter's pencil, or other marking instrument is rotated about a fixed point to draw circles, arcs, or intersecting arcs on template paper, sheet metal, plywood, drywall, and similar construction materials.

8. The tool of claim 7, wherein said rear wall disposes two or more extruded contours defining predetermined geometry and spacing for positioning marking instruments disposing various diameters or transient geometrical cross sections.

9. The tool of claim 7, wherein said front wall disposes a thumb screw located symmetrical of said extruded contours.

10. The tool of claim 9, wherein said thumb screw forces a marking instrument against tangents defined by said extruded contours to adequately position and fasten a variety of marking instruments to a tape measure housing, trammels, dividers and similar devices wherein a marking instrument is rotated about a fixed point to draw circles, arcs, and intersecting arcs on template paper, sheet metal, plywood, drywall, and similar construction materials.
